(19) United States
(12) Patent Application Publication
(10) Pub. No.: US 2014/0356127 A1
(43) Pub. Date: Dec. 4, 2014

(54) METHOD AND PUMP FOR PUMPING HIGHLY VISCOUS FLUIDS

(71) Applicant: Sulzer Pumpen AG, Winterthur (CH)

(72) Inventor: Johann Guelich, Winterthur (CH)

(21) Appl. No.: 14/365,704

(22) PCT Filed: Nov. 28, 2012
(86) PCT No.: PCT/EP2012/073829

§ 371 Date: Jun. 16, 2014

(30) Foreign Application Priority Data
Dec. 20, 2011 (EP) 11194682.8

(51) Int. Cl. F04D 7/04; F04D 27/00

(52) U.S. Cl. CPC F04D 7/045; F04D 27/006; F05D 2210/20; F05D 2260/20
USPC 415/1; 415/58.6

(57) ABSTRACT

A pump (1) for pumping highly viscous fluids is presented that includes a casing (3), an inlet (7), an outlet (8) and a closed impeller (5) rotatably arranged in the casing between the inlet and the outlet and that has a side room (6) between a shroud (4) of the impeller and the casing (3). In addition, the pump (1) includes a sealing element (7a, 7b, 8a, 8b) between the impeller (5) and the casing (3) each at an inlet side and at an outlet side of the impeller for restricting back flow through the side room (6) and for allowing the fluid contained in the side room to heat up, and an injection port (9) leading into the side room (6) for injecting a fluid into the side room for diminishing disk friction between the shroud (4) of the impeller and the casing (3).

The invention relates to a method and to a pump for pumping highly viscous fluids according to the preamble of claim 1 and claim 10 respectively.

Highly viscous fluids such as heavy oil or other products can be pumped by means of conventional centrifugal pumps or positive displacement pumps. Centrifugal pumps have the advantage that they generate only a small pulsation compared to positive displacement pumps and that they do not need a security valve. Moreover, centrifugal pumps allow a simple flow control. They are therefore frequently used in chemical industry and in oil refineries. It has, however, to be taken into account that the performance of centrifugal pumps depends on the viscosity of the pumped fluid. For higher viscosities the power losses increase considerably resulting in lower head, lower flow rate and lower efficiency of the centrifugal pump.

The viscosity is a measure for the internal friction generated in a flowing fluid and a characteristic property of the fluid. In the following the so-called kinematic viscosity v is used. Fluids having a kinematic viscosity of more than 10⁻⁴ m²/s are called highly viscous fluids in the present specification.

The characteristics of a centrifugal pump for pumping viscous fluids can be determined for example with the aid of empirical correction factors when the characteristics for pumping water are known. These correction factors are averages from test results and may lead to inaccurate predictions when pump geometries are changed.

From C. P. Hamkins et al. “Prediction of viscosity effects in centrifugal pumps by consideration of individual losses”, ImechE paper C112/87, 207-217, 1987 a one-dimensional prediction method is known which allows to calculate the viscosity effects. This method can e.g. be used for designing impellers for pumping highly viscous fluids.

The power increase in pumping highly viscous fluids is mainly caused by disc friction losses. For a given application defined by the operation point in the viscous flow, the disc friction losses can be reduced by using impellers with high head coefficients ψ of for example greater than 1.05 or greater than 1.10. The head coefficient of the impeller can be increased in that e.g. the blade outlet angle and/or the number of blades and/or the impeller outlet width are increased. A given hydraulic output is than achieved with a smaller impeller diameter which yields lower disc friction losses.

Pumping of highly viscous fluid is possible up to a kinematic viscosity of about 5·10⁻³ m²/s. However, the use of centrifugal pumps already tends to become uneconomic at viscosity values of 5·10⁻⁴ m²/s and higher. The increased power requirement of centrifugal pumps for pumping highly viscous fluids and the limitation to viscosity values of typically below 5·10⁻⁴ m²/s are disadvantageous.

It is an object of the present invention to provide a method and a pump for pumping highly viscous fluids wherein the pump efficiency is improved compared to corresponding conventional pumping methods and to corresponding conventional pumps.

This object is satisfied in accordance with the invention by the method defined in claim 1 and by the pump defined in claim 10.

The method according to the invention for pumping highly viscous fluids includes providing a pump having a casing, an inlet, an outlet and a closed or semi-open impeller rotatably arranged in the casing between the inlet and the outlet, pumping highly viscous fluid from the inlet to the outlet of the pump, thereby causing either a back flow or a recirculation flow of the fluid or both, with the back flow flowing through a first side room between a front shroud of the impeller and the casing, and with the recirculation flow exchanging fluid between the pumped fluid and the first side room and/or a second side room between a rear shroud of the impeller and the casing. In the method disk friction between the front and/or rear shroud of the impeller on the one hand and the casing on the other hand is diminished by restricting the back flow and/or recirculation flow and by reducing the viscosity of the fluid contained in the first and/or second side room respectively either by increasing the temperature of the fluid contained in the respective side room by at least 10° C. above the temperature of the pumped fluid, or by injecting a fluid into the respective side room, or by both, with the injected fluid having a viscosity which is lower than the viscosity of the pumped fluid. The temperature of the pumped fluid can for example be measured in a collector part of the casing such as a volute for collecting the pumped fluid coming out from the impeller.

In the context of the present specification an impeller having a front shroud and a rear shroud is referred to as a closed impeller while an impeller having a rear shroud but no front shroud is called a semi-open impeller.

The viscosity of the fluid contained in the first and/or second side room respectively is advantageously reduced by for example more than 16% or more than 24% or more than 40% with respect to the viscosity of the pumped fluid.

The temperature of the fluid contained in the respective side room is typically at least 12° C. or at least 16° C. or at least 24° C. higher than the temperature of the pumped fluid.

In an advantageous embodiment of the method the temperature of the fluid contained in the respective side room is increased by active heating with a heater and/or by injecting a heated fluid. In another advantageous embodiment the temperature of the fluid contained in the respective side room is increased by passive heating in that for passive heating the back flow or recirculation flow is respectively restricted such that the heat flow equilibrium in the respective side room between the heat generated by disk friction on the one hand and the heat removed by convection and transmission on the other hand is achieved at a temperature which is at least 10° C. higher than the temperature of the pumped fluid.

The back flow can e.g. be restricted by providing a sealing element between the impeller and the casing at an inlet side of the impeller. It is further possible to restrict the back flow and/or recirculation flow respectively by providing a sealing element between the impeller and the casing at an outlet side of the impeller.

The viscosity of the injected fluid is typically lower than the viscosity of the pumped fluid by a factor of at least 1.6 or at least 2 or of at least 3.

In an advantageous embodiment the injected fluid has a higher temperature than the pumped fluid and/or than the fluid contained in the respective side room. The injected fluid can e.g. be taken from the pumped fluid and be heated prior to injection. In another advantageous embodiment the injected fluid is a diluent for diluting the fluid contained in the respective side room. A light fuel oil or diesel fuel oil can e.g. be used as a diluent when highly viscous oils or highly viscous fluids are pumped.

The viscosity of the pumped fluid is typically at least 5·10⁻⁵ m²/s or at least 2·10⁻⁴ m²/s or at least 5·10⁻⁴ m²/s.

The pump according to the invention for pumping highly viscous fluids includes a casing, an inlet, an outlet and a closed or semi-open impeller rotatably arranged in the casing between the inlet and the outlet and has either a first side room between a front shroud of the impeller and the casing or a second side room between a rear shroud of the impeller and the casing or both. The pump according to the invention is further provided with either a sealing element between the impeller and the casing at an inlet side of the impeller or at least one sealing element between the impeller and the casing at an outlet side of the impeller or both, and/or with an injection port leading into the respective side room, with the sealing element at the inlet side of the impeller being able to restrict back flow through the first side room, with the sealing element at the outlet side of the impeller being able to restrict the back flow through the first side room and/or to restrict recirculation flow between the pumped fluid and the first or second side room, and with said sealing element or elements allowing the fluid contained in the respective side room to heat up in operation to temperatures of at least 10° C. above the temperature of the pumped fluid for reducing the viscosity of the fluid contained in the respective side room, and with the injection port allowing to inject a fluid into the respective side room for reducing the viscosity of the fluid contained in the respective side room.

In an advantageous embodiment the sealing element or elements is/are able to restrict the back flow or recirculation flow such that in the respective side room the heat flow equilibrium between the heat generated by disk friction on the one hand and the heat removed by convection and transmission on the other hand is achieved in operation at a temperature which is at least 10° C. higher than the temperature of the pumped fluid for diminishing disk friction between the front or rear shroud of the impeller and the casing.

In another advantageous embodiment the pump includes at least one heater for heating the fluid in the respective side room, or for heating the fluid to be injected into the respective side room, for diminishing disk friction between the front or rear shroud of the impeller and the casing respectively.

The pump can additionally include a fluid source connected to the injection port for providing fluid for injection into the respective side room.

The sealing element or elements at the inlet or outlet side of the impeller can e.g. be or contain a sealing gap or comb seal or brush seal or floating ring seal or piston ring or combinations thereof.

In a further advantageous embodiment the impeller has a high head coefficient, for example a head coefficient higher than 1.05 or higher than 1.10.

The method and pump according the invention have the advantage that, due to the lower viscosity of the fluid in the respective side room between the front and/or rear shroud of the impeller and the casing, disk friction is reduced and the efficiency is improved compared to corresponding conventional pumping methods and to corresponding conventional pumps.

The above description of the embodiments and variants serves merely as an example. Further advantageous embodiments can be seen from the dependent claims and the drawing. Moreover, in the context of the present invention, individual features from the described or illustrated embodiments and from the described or illustrated variants can be combined with one another in order to form new embodiments.

In the following the invention will be explained in more detail with reference to the specific embodiment and with reference to the drawing.

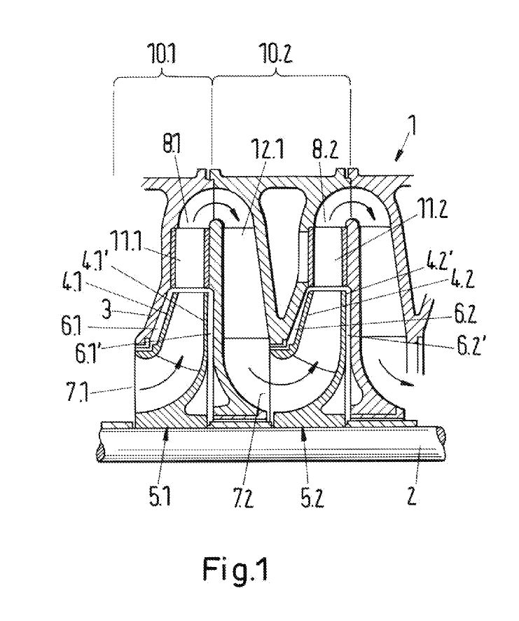

FIG. 1 is a longitudinal section through two stages of a multistage pump according to prior art;

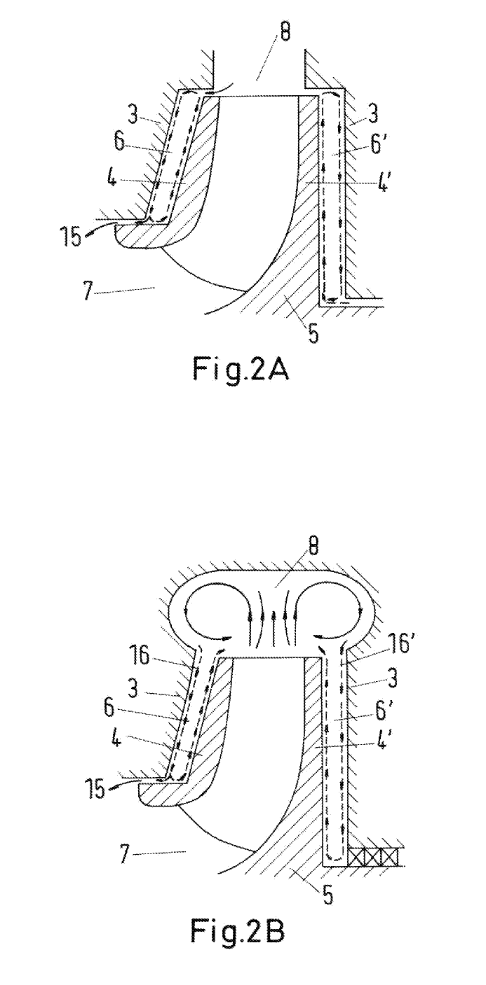

FIG. 2A is a longitudinal section through a single pump stage illustrating back flow;

FIG. 2B is a schematic view of a longitudinal section through a single pump stage illustrating recirculation flow;

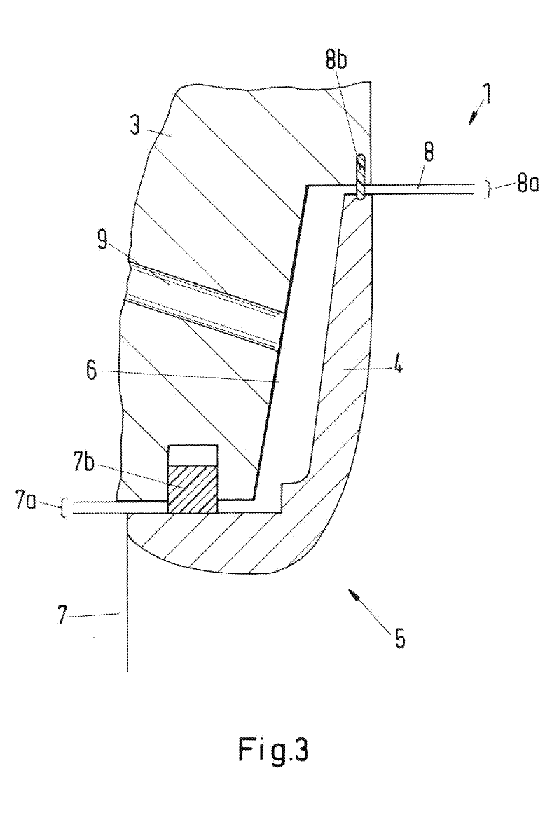

FIG. 3 is a detailed view of an impeller and a casing of a pump according to an embodiment of the present invention; and

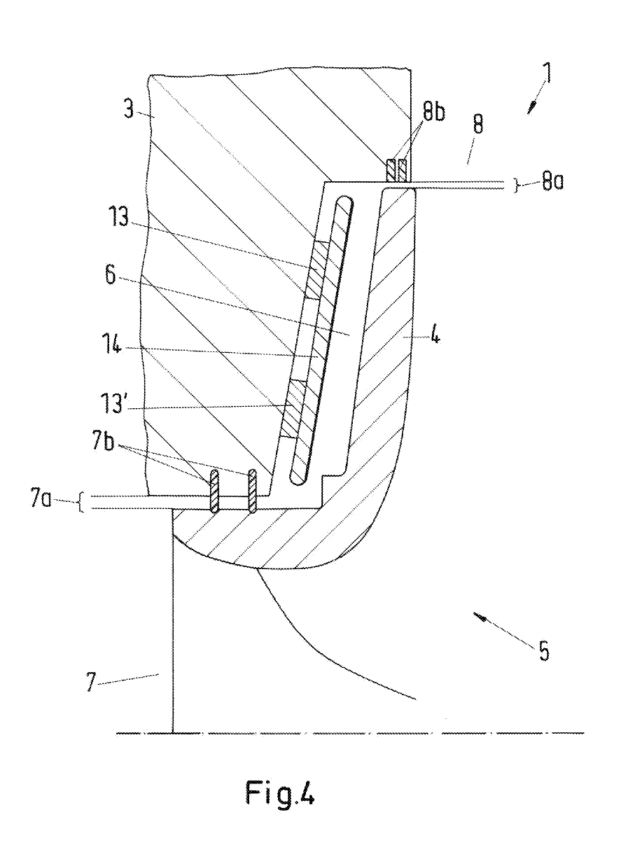

FIG. 4 is a detailed view of an impeller and a casing of a pump according to a second embodiment of the present invention.

FIG. 1 shows a longitudinal section through two stages of a multistage pump according to prior art. The pump 1 has at least two consecutive pump stages 10.1, 10.2 for pumping highly viscous fluids and may have as many stages as appropriate. Each stage includes an inlet 7.1, 7.2, an outlet 8.1, 8.2 and a closed impeller 5.1, 5.2. The outlet 8.1 of the first stage 10.1 is connected via a crossover 12.1 with the inlet 7.2 of the second stage 10.2. The pump 1 further includes a casing 3 and side rooms 6.1, 6.1′, 6.2, 6.2′ each formed between a front shroud 4.1, 4.2 or a rear shroud 4.1′, 4.2′ of the respective impeller and the casing. Moreover, the pump may further comprise a common shaft 2 on which the impellers 5.1, 5.2 are attached and diffuser elements 11.1, 11.2 which can optionally be arranged at the outlet side of the impellers.

FIG. 2A is a longitudinal section through a single pump stage illustrating back flow through a side room 6 formed between a front shroud 4 of the impeller 5 and the casing 3. A back flow 15 flowing from the outlet 8 to the inlet 7 through the side room 6 is caused when fluid is pumped from the inlet to the outlet. The losses due to the back flow through the side room 6 decreases as the viscosity of the pumped fluid increases and are therefore usually of minor concern when pumping highly viscous fluids.

FIG. 2B is a schematic view of a longitudinal section through a single pump stage illustrating recirculation flow flowing into and out of a side room 6, 6′ formed respectively between a front shroud 4 or a rear shroud 4′ of the impeller 5 and the casing 3. The recirculation flow 16, 16′, which exchanges fluid between the pumped fluid and either of or both of the side rooms 6, 6′, is caused when fluid is pumped from the inlet 7 to the outlet 8. The losses due to the recirculation flow decreases as the viscosity of the pumped fluid increases and are therefore usually of minor concern when pumping highly viscous fluids.

A detailed view of an impeller and a casing of a pump 1 according to an embodiment of the present invention is shown in FIG. 3. The pump 1 according to the invention for pumping highly viscous fluid includes a casing 3, an inlet 7, an outlet 8 and a closed or semi-open impeller 5 rotatably arranged in the casing between the inlet and the outlet and has either a first side room 6 between a front shroud 4 of the impeller and the casing 3 or a second side room not shown in FIG. 3 between a rear shroud of the impeller and the casing or both. The pump 1 according to the invention is further provided with either a sealing element 7a, 7b between the impeller 5 and the casing 3 at an inlet side of the impeller or at least one sealing element 8a, 8b between the impeller 5 and the casing 3 at an outlet side of the impeller or both, and/or with an injection port 9 leading into the respective side room 6.

The sealing element 7a, 7b at the inlet side of the impeller is able to restrict back flow through the first side room 6, and the sealing element 8a, 8b at the outlet side of the impeller is able to restrict the back flow through the first side room 6 and/or to restrict recirculation flow between the pumped fluid and the first or second side room 6, with the sealing element or elements 7a, 7b, 8a, 8b allowing the fluid contained in the respective side room 6 to heat up in operation to temperatures of at least 10° C. above the temperature of the pumped fluid for reducing the viscosity of the fluid contained in the respective side room 6. In addition or alternatively, the injection port 9 allows injecting a fluid into the respective side room 6 for reducing the viscosity of the fluid contained in the respective side room.

The sealing element or elements is/are advantageously able to restrict the back flow and/or recirculation flow such that in the respective side room 6 the heat flow equilibrium between the heat generated by disk friction on the one hand and the heat removed by convection and transmission on the other hand is achieved in operation at a temperature which is at least 10° C. higher than the temperature of the pumped fluid for diminishing disk friction between the front or rear shroud of the impeller and the casing.

The pump 1 can additionally include a fluid source (not shown in FIG. 3) connected to the injection port 9 for providing fluid for injection into the respective side room 6.

The sealing element or elements 7a, 7b, 8a, 8b at the inlet or outlet side of the impeller 5 can e.g. be or contain a sealing gap or labyrinth seal or comb seal or brush seal or floating ring seal or piston ring or combinations thereof. In the embodiment shown in FIG. 3, the pump 1 for example includes a sealing gap 7a and a floating ring seal 7b at the inlet side of the impeller 5, and a sealing gap 8a and a brush seal 8b at the outlet side of the impeller.

FIG. 4 is a detailed view of an impeller and a casing of a pump 1 according to a second embodiment of the present invention. The pump 1 according to the invention for pumping highly viscous fluid includes a casing 3, an inlet 7, an outlet 8 and a closed or semi-open impeller 5 rotatably arranged in the casing between the inlet and the outlet and has either a first side room 6 between a front shroud 4 of the impeller and the casing 3 or a second side room not shown in FIG. 4 between a rear shroud of the impeller and the casing or both. The pump 1 according to the invention is further provided with either a sealing element 7a, 7b between the impeller 5 and the casing 3 at an inlet side of the impeller or at least one sealing element 8a, 8b between the impeller 5 and the casing 3 at an outlet side of the impeller or both, and/or with an injection port, not shown in FIG. 4, which leads into the respective side room.

The sealing element 7a, 7b at the inlet side of the impeller is able to restrict back flow through the first side room 6, and the sealing element 8a, 8b at the outlet side of the impeller is able to restrict the back flow through the first side room 6 and/or to restrict recirculation flow between the pumped fluid and the first or second side room 6, with the sealing element or elements 7a, 7b, 8a, 8b allowing the fluid contained in the respective side room 6 to heat up in operation to temperatures of at least 10° C. above the temperature of the pumped fluid for reducing the viscosity of the fluid contained in the respective side room 6. In addition or alternatively, the injection port allows injecting a fluid into the respective side room for reducing the viscosity of the fluid contained in the respective side room.

In the second embodiment the pump 1 further includes at least one heater 14 for heating the fluid in the respective side room 6, or for heating the fluid to be injected into the respective side room, for reducing the viscosity of the fluid contained in the respective side room and diminishing disk friction between the front or rear shroud of the impeller and the casing respectively. The at least one heater 14 can e.g. be mounted, as shown in FIG. 4, with insulators 13, 13′ on the casing 3.

The sealing element or elements 7a, 7b, 8a, 8b at the inlet or outlet side of the impeller 5 can e.g. be or contain a sealing gap or labyrinth seal or comb seal or brush seal or floating ring seal or piston ring or combinations thereof. In the embodiment shown in FIG. 4, the pump 1 for example includes a sealing gap 7a and a comb seal 7b at the inlet side of the impeller 5, and a sealing gap 8a with serrations 8b at the outlet side of the impeller.

For further advantageous design features and variants it is referred to the above description of the embodiment shown in FIG. 3.

Independent of the embodiment or design variant the pump 1 can for example be implemented as a radial or axial or mixed flow pump and can have one stage or two or more stages as shown in FIG. 1.

It can further be advantageous to equip the pump 1 with an impeller or with impellers having a high head coefficient, for example a head coefficient higher than 1.05 or higher than 1.10, for reducing the active surface area of the shroud or shrouds and for diminishing disk friction.

An impeller having a high head coefficient has a blade outlet angle which is typically greater than 30° or greater than 40° or greater than 50°, and/or has typically more than 6 or more than 8 ore more than 12 blades, and/or has an impeller outlet width which is typically greater than 0.16·(D₂−D₁) or greater than 0.24·(D₂−D₁), where D₁ denotes the diameter of the leading edge of the blades and D₂ denotes the diameter of the trailing edge of the blades in the median section of the blades.

Generally high head coefficient impellers are rarely selected due to unstable characteristics obtained with these impellers when pumping water or lower viscosity fluids. The characteristics of high head coefficient impellers, however, tend to be more stable when pumping highly viscous fluids. Thus, for pumping highly viscous fluids the blade outlet angle, blade number and impeller outlet width can be selected larger than usual for pumping lower viscosity fluids such as water.

An embodiment of the method in accordance with the invention for pumping highly viscous fluids will be described in the following with reference to FIGS. 2A to 4. The method in accordance with the invention includes providing a pump 1 having a casing 3, an inlet 7, an outlet 8 and a closed or semi-open impeller 5 rotatably arranged in the casing between the inlet and the outlet, pumping highly viscous fluid from the inlet to the outlet of the pump, thereby causing either a back flow 15 or a recirculation flow 16, 16′ of the fluid or both, with the back flow 15 flowing through a first side room 6 between a front shroud 4 of the impeller and the casing 3, and with the recirculation 16, 16′ flow exchanging fluid between the pumped fluid and the first side room 6 and/or a second side room 6′ between a rear shroud 4′ of the impeller and the casing 3.

In the method in accordance with the invention disk friction between the front and/or rear shroud 4, 4′ of the impeller on the one hand and the casing 3 on the other hand is diminished by restricting the back flow 15 and/or recirculation flow 16, 16′ and by reducing the viscosity of the fluid contained in the first and/or second side room 6, 6′ respectively, either by increasing the temperature of the fluid contained in the respective side room 6, 6′ by at least 10° C. above the temperature of the pumped fluid, or by injecting a fluid into the respective side room 6, 6′, or by both, with the injected fluid having a viscosity which is lower than the viscosity of the pumped fluid.

The viscosity of the fluid contained in the first and/or second side room 6, 6′ respectively is advantageously reduced by for example more than 16% or more than 24% or more than 40% with respect to the viscosity of the pumped fluid.

The temperature of the fluid contained in the respective side room 6, 6′ is typically at least 12° C. or at least 16° C. or at least 24° C. higher than the temperature of the pumped fluid.

In an advantageous embodiment of the method the temperature of the fluid contained in the respective side room 6, 6′ is increased by active heating with a heater 14 and/or by injecting a heated fluid. In another advantageous embodiment the temperature of the fluid contained in the respective side room 6, 6′ is increased by passive heating in that for passive heating the back flow 15 or recirculation flow 16, 16′ is respectively restricted such that the heat flow equilibrium in the respective side room between the heat generated by disk friction on the one hand and the heat removed by convection and transmission on the other hand is achieved at a temperature which is at least 10° C. higher than the temperature of the pumped fluid.

The back flow 15 can e.g. be restricted by providing a sealing element 7a, 7b between the impeller 5 and the casing 3 at an inlet side of the impeller. It is further possible to restrict the back flow 15 and/or recirculation flow 16, 16′ respectively by providing one or more sealing elements 8a, 8b between the impeller 5 and the casing 3 at an outlet side of the impeller.

The viscosity of the injected fluid is typically lower than the viscosity of the pumped fluid by a factor of at least 2 or of at least 3.

In an advantageous embodiment of the method the injected fluid has a higher temperature than the pumped fluid and/or than the fluid contained in the respective side room. The injected fluid can e.g. be taken from the pumped fluid and be heated prior to injection. In another advantageous embodiment the injected fluid is a diluent for diluting the fluid contained in the respective side room. A light fuel oil or diesel fuel oil can e.g. be used as a diluent for pumping highly viscous oils or highly viscous fluids.

It can further be advantageous to equip the pump 1 with an impeller or with impellers having a high head coefficient, for example a head coefficient higher than 1.05 or higher than 1.10, for reducing the active surface area of the shroud or shrouds and for diminishing disk friction.

The viscosity of the pumped fluid is typically at least 5·10⁻⁵ m²/s or at least 2·10⁻⁴ m²/s or at least 5·10⁻⁴ m²/s.

The method and pump according the invention for pumping highly viscous fluids have the advantage that they allow building more economic pumping installations since the pump drive can be less powerful due to a lower disk friction and, thus, to lower power losses of the pump compared to the power losses of conventional pumps for pumping highly viscous fluids.

1. A method for pumping highly viscous fluids includes providing a pump (1) having a casing (3), an inlet (7), an outlet (8) and a closed or semi-open impeller (5) rotatably arranged in the casing between the inlet and the outlet, pumping highly viscous fluid from the inlet to the outlet of the pump, thereby causing either a back flow (15) or a recirculation flow (16, 16′) of the fluid or both, with the back flow (15) flowing through a first side room (6) between a front shroud (4) of the impeller and the casing (3), and with the recirculation (16, 16′) flow exchanging fluid between the pumped fluid and the first side room (6) and/or a second side room (6′) between a rear shroud (4′) of the impeller and the casing (3), wherein disk friction between the front and/or rear shroud (4, 4′) of the impeller on the one hand and the casing (3) on the other hand is diminished by restricting the back flow (15) and/or recirculation flow (16, 16′) and by reducing the viscosity of the fluid contained in the first and/or second side room (6, 6′) respectively, either by increasing the temperature of the fluid contained in the respective side room (6, 6′) by at least 10° C. above the temperature of the pumped fluid, or by injecting a fluid into the respective side room (6, 6′), or by both, with the injected fluid having a viscosity which is lower than the viscosity of the pumped fluid.

2. The method according to claim 1, wherein the viscosity of the fluid contained in the first and/or second side room (6, 6′) respectively is reduced by more than 16% or more than 24% or more than 40% with respect to the viscosity of the pumped fluid.

3. The method according to claim 1, wherein the temperature of the fluid contained in the respective side room (6, 6′) is at least 12° C. or at least 16° C. or at least 24° C. higher than the temperature of the pumped fluid.

4. The method according to claim 1, wherein the temperature of the fluid contained in the respective side room (6, 6′) is increased by active heating with a heater (14) and/or by injecting a heated fluid, and/or by passive heating in that for passive heating the back flow (15) and/or recirculation flow (16, 16′) is respectively restricted such that the heat flow equilibrium in the respective side room (6, 6′) between the heat generated by disk friction on the one hand and the heat removed by convection and transmission on the other hand is achieved at a temperature which is at least 10° C. higher than the temperature of the pumped fluid.

5. The method according to claim 1, wherein the back flow (15) is restricted by providing a sealing element (7a, 7b) between the impeller (5) and the casing (3) at an inlet side of the impeller.

6. The method according to claim 1, wherein the back flow (15) and/or recirculation flow (16, 16′) is respectively restricted by providing a sealing element (8a, 8b) between the impeller (5) and the casing (3) at an outlet side of the impeller.

7. The method according to claim 1, wherein the injected fluid has a viscosity which is lower than the viscosity of the pumped fluid by a factor of at least 2 or of at least 3.

8. The method according to claim 7, wherein the injected fluid has a higher temperature than the fluid contained in the respective side room (6, 6′) and/or wherein the injected fluid dilutes the fluid contained in the respective side room (6, 6′).

9. The method according to claim 1, wherein the viscosity of the pumped fluid is at least 5·10⁻⁵ m²/s or at least 2·10⁻⁴ m²/s or at least 5·10⁻⁴ m²/s.

10. A pump (1) for pumping highly viscous fluids including a casing (3), an inlet (7), an outlet (8) and a closed or semi-open impeller (5) rotatably arranged in the casing between the inlet and the outlet, with the pump having either a first side room (6) between a front shroud (4) of the impeller and the casing (3) or a second side room (6′) between a rear shroud (4′) of the impeller and the casing (3) or both, wherein the pump (1) is provided with either a sealing element (7a, 7b) between the impeller (5) and the casing (3) at an inlet side of the impeller or at least one sealing element (8a, 8b) between the impeller (5) and the casing (3) at an outlet side of the impeller or both, and/or with an injection port (9) leading into the respective side room (6, 6′), with the sealing element (7a, 7b) at the inlet side of the impeller being able to restrict back flow (15) through the first side room (6), with the sealing element (8a, 8b) at the outlet side of the impeller being able to restrict the back flow (15) through the first side room (6) and/or to restrict recirculation flow (16, 16′) between the pumped fluid and the first or second side room (6, 6′), and with said sealing element or elements (7a, 7b, 8a, 8b) allowing the fluid contained in the respective side room (6, 6′) to heat up in operation to temperatures of at least 10° C. above the temperature of the pumped fluid for reducing the viscosity of the fluid contained in the respective side room (6, 6′), and with the injection port (9) allowing to inject a fluid into the respective side room for reducing the viscosity of the fluid contained in the respective side room (6, 6′).

11. The pump according to claim 10, wherein the sealing element or elements (7a, 7b, 8a, 8b) are able to restrict the back flow (15) or recirculation flow (16, 16′) such that in the respective side room (6, 6′) the heat flow equilibrium between the heat generated by disk friction on the one hand and the heat removed by convection and transmission on the other hand is achieved in operation at a temperature which is at least 10° C. higher than the temperature of the pumped fluid.

12. The pump according to claim 10, including at least one heater for heating the fluid in the respective side room (6, 6′), or for heating the fluid to be injected into the respective side room, for diminishing disk friction between the front or rear shroud (4, 4′) of the impeller and the casing (3) respectively.

13. The pump according to claim 10, additionally including a fluid source connected to the injection port (9) for providing fluid for the injection into the respective side room (6, 6′).

14. The pump according to claim 10, wherein the sealing element or elements (7a, 7b, 8a, 8b) at the inlet or outlet side of the impeller (5) is/are implemented as or contains/contain a sealing gap or a comb seal or a brush seal or a floating ring seal or a piston ring.

15. The pump according to claim 10, wherein the impeller (5) has a high head coefficient, in particular a head coefficient higher than 1.05 or higher than 1.10.
